(19) United States
(12) Patent Application Publication
(10) Pub. No.: US 2022/0058497 A1
(43) Pub. Date: Feb. 24, 2022

(54) SYSTEMS AND METHODS FOR FAULT DIAGNOSTICS IN BUILDING AUTOMATION SYSTEMS

(71) Applicant: Siemens Industry, Inc., Alpharetta, GA (US)

(72) Inventors: Jose Vazquez-Canteli, Austin, TX (US); Zhen Song, Austin, TX (US); Megan McHugh, Pflugerville, TX (US); Gregory Conte, Gulf Breeze, FL (US)

(21) Appl. No.: 16/999,225

(22) Filed: Aug. 21, 2020

(51) Int. Cl. G06N 5/04; G06N 5/02; G06N 7/00; G05B 19/042

(52) U.S. Cl. CPC G06N 5/04; G06N 5/022; G05B 2219/25011; G05B 19/042; G06N 7/005

(57) ABSTRACT

Methods for failure analysis in a building automation system and corresponding systems and computer-readable mediums. A method includes receiving device event data for a plurality of devices and executing a fault diagnostics inference engine to determine faults corresponding to the device event data. The fault diagnostics inference engine includes a dynamic Bayesian network and a conditional probability table. The method includes executing a predictive maintenance engine to produce probabilities of hardware failures based on the determined faults and the device event data. The method includes updating the conditional probability table based on the probabilities of hardware failures. The method includes producing updated faults by the predictive maintenance engine according to the updated conditional probability table. The method includes displaying the updated faults.

### CROSS-REFERENCE TO OTHER APPLICATIONS

The present disclosure includes some subject matter in common with, but is otherwise unrelated to, concurrently filed patent applications ______ (entitled “Systems And Methods to Assess and Repair Data Using Data Quality Indicators”) and ______ (entitled “Systems And Methods For HVAC Equipment Predictive Maintenance Using Machine Learning”) which are hereby incorporated by reference.

### TECHNICAL FIELD

The present disclosure is directed, in general, to systems and methods for root-cause diagnostics in building-control systems and other systems.

### BACKGROUND OF THE DISCLOSURE

Building automation systems encompass a wide variety of systems that aid in the monitoring and control of various aspects of building operation. Building automation systems include security systems, fire safety systems, lighting systems, and heating, ventilation, and air conditioning (HVAC) systems. The elements of a building automation system are widely dispersed throughout a facility. For example, an HVAC system may include temperature sensors and ventilation damper controls, as well as other elements that are located in virtually every area of a facility. These building automation systems typically have one or more centralized control stations from which system data may be monitored and various aspects of system operation may be controlled and/or monitored.

To allow for monitoring and control of the dispersed control system elements, building automation systems often employ multi-level communication networks to communicate operational and/or alarm information between operating elements, such as sensors and actuators, and the centralized control station. One example of a building automation system is the DXR Controller, available from Siemens Industry, Inc. Building Technologies Division of Buffalo Grove, Ill. (“Siemens”). In this system, several control stations connected via an Ethernet or another type of network may be distributed throughout one or more building locations, each having the ability to monitor and control system operation.

To ensure correct operation of the building automation or control systems, it can be important to ensure that the data generated by the physical sensors and other devices accurately reflects the state of the system, and that the causes of faults in the operation of the system are properly identified. Current systems typically cannot detect minor faults until a problem is severe enough for an operator or user to notice it, and fault diagnostics can require physical inspection of components to determine which elements have failed and what caused the failures. Improved systems are desirable.

### SUMMARY OF THE DISCLOSURE

This disclosure describes systems and methods for failure analysis in a building automation system and corresponding systems and computer-readable mediums. A method includes receiving device event data for a plurality of devices and executing a fault diagnostics inference engine to determine faults corresponding to the device event data. The fault diagnostics inference engine includes a dynamic Bayesian network and a conditional probability table. The method includes executing the predictive maintenance engine to produce probabilities of hardware failures based on the determined faults and the device event data. The method includes updating the conditional probability table based on the probabilities of hardware failures. The method includes producing updated faults by the predictive maintenance engine according to the updated conditional probability table. The method includes displaying the updated faults.

In some embodiments, the faults include one or more of control-logic configuration faults, software and human-induced faults, or hardware faults. In some embodiments, the updated faults include control-logic configuration faults. In some embodiments, the fault diagnostics inference engine includes a plurality of digital twins each corresponding to a different device. In some embodiments, each digital twin includes a respective Bayesian network. In some embodiments, the fault diagnostics inference engine maintains links between Bayesian networks of digital twins corresponding to different devices. In some embodiments, each digital twin includes a respective conditional probability table. In some embodiments, each digital twin includes a respective voting network. In some embodiments, the predictive maintenance engine produces initial and ongoing probabilities of faults as a function of time. In some embodiments, the predictive maintenance engine calculates a probability of failure at any time interval for a device from an annual failure rate of the device.

Various embodiments include a building automation system including a data processing system for processing device event data for a plurality of devices in the building automation system, configured to perform processes as described herein. Various embodiments include a non-transitory computer-readable medium storing executable code that, when executed, causes a data processing system of a building automation system to perform processes as described herein.

The foregoing has outlined rather broadly some features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a building automation system in which the data quality of a heating, ventilation, and air conditioning (HVAC) system or other systems may be improved in accordance with the present disclosure;

FIG. 2 illustrates details of one of the field panels of FIG. 1 in accordance with the present disclosure;

FIG. 3 illustrates details of one of the field controllers of FIG. 1 in accordance with the present disclosure;

FIG. 4A and FIG. 4B illustrate the use of air heating units in a building automation system in accordance with disclosed embodiments;

FIG. 5 illustrates an example of a causal network for fault diagnosis analysis in an HVAC control-logic configuration in accordance with disclosed embodiments;

FIG. 6 illustrates an example of elements of a software architecture in accordance with disclosed embodiments;

FIG. 7 illustrates an example of a survival curve from predictive maintenance in accordance with disclosed embodiments;

FIG. 8 illustrates an example of a structure of a fault diagnostics inference engine in accordance with disclosed embodiments;

FIG. 9 illustrates an inference engine in accordance with disclosed embodiments;

FIG. 10 illustrates an example of a process in accordance with disclosed embodiments; and

FIG. 11 illustrates a block diagram of a data processing system in which various embodiments can be implemented.

### DETAILED DESCRIPTION

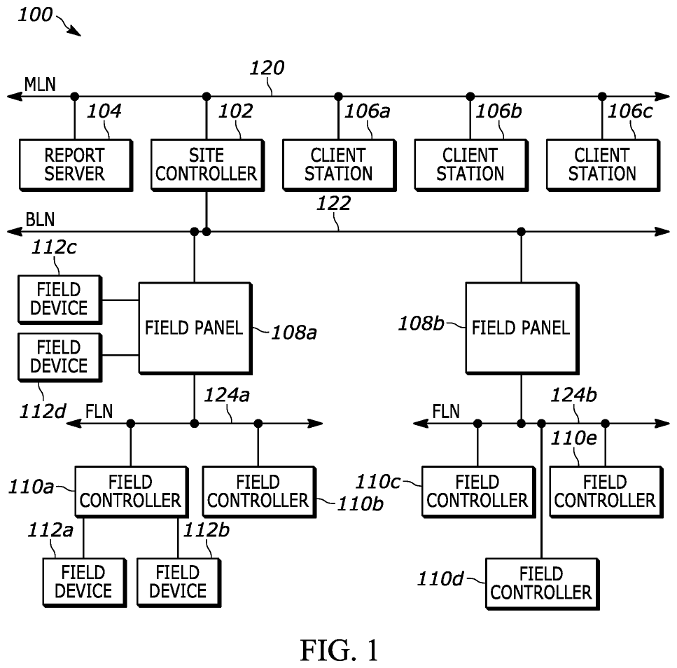

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

A building automation system (BAS) such as disclosed herein can operate in an automatic operation mode that helps operate systems in the space efficiently to save energy. The BAS continuously evaluates environmental conditions and energy usage in the space and can determine and indicate to users when the space is being operated most efficiently. Similarly, the BAS can determine and indicate when the systems operate inefficiently, such as due to an occupant overriding the room control because of personal preference or due to weather conditions change drastically. The BAS can automatically, or at the input of a user, adjust the control settings to make the systems operate efficiently again.

For proper operation of the BAS, the BAS collects data from many sensors and other devices that are located, for example, in the rooms of the building, within the ventilation systems, as part of the heating, cooling, or ventilation devices, and otherwise throughout the building and system. Low-quality data, such as missing data points or data points that are not accurate reflections of the building or system conditions, can cause incorrect or inefficient operation.

Disclosed embodiments include systems and methods for automated analysis of the quality of the data being processed and correction of the data to ensure proper operation of the BAS.

FIG. 1 illustrates a block diagram of a building automation system 100 in which disclosed embodiments can be implemented. The building automation system 100 is an environmental control system configured to control at least one of a plurality of environmental parameters within a building, such as temperature, humidity, lighting and/or the like. For example, for a particular embodiment, the building automation system 100 may comprise the DXR Controller building automation system that allows the setting and/or changing of various controls of the system. While a brief description of the building automation system 100 is provided below, it will be understood that the building automation system 100 described herein is only one example of a particular form or configuration for a building automation system and that the system 100 may be implemented in any other suitable manner without departing from the scope of this disclosure.

For the illustrated embodiment, the building automation system 100 comprises a site controller 102, a report server 104, a plurality of client stations 106a-c, a plurality of field panels 108a-b, a plurality of field controllers 110a-e and a plurality of field devices 112a-d. Although illustrated with three client stations 106, two field panels 108, five field controllers 110 and four field devices 112, it will be understood that the system 100 may comprise any suitable number of any of these components 106, 108, 110 and 112 based on the particular configuration for a particular building.

The site controller 102, which may comprise a computer or a general-purpose processor, is configured to provide overall control and monitoring of the building automation system 100. The site controller 102 may operate as a data server that is capable of exchanging data with various elements of the system 100. As such, the site controller 102 may allow access to system data by various applications that may be executed on the site controller 102 or other supervisory computers (not shown in FIG. 1).

For example, the site controller 102 may be capable of communicating with other supervisory computers, Internet gateways, or other gateways to other external devices, as well as to additional network managers (which in turn may connect to more subsystems via additional low-level data networks) by way of a management level network (MLN) 120. The site controller 102 may use the MLN 120 to exchange system data with other elements on the MLN 120, such as the report server 104 and one or more client stations 106. The report server 104 may be configured to generate reports regarding various aspects of the system 100. Each client station 106 may be configured to communicate with the system 100 to receive information from and/or provide modifications to the system 100 in any suitable manner. The MLN 120 may comprise an Ethernet or similar wired network and may employ TCP/IP, BACnet, and/or other protocols that support high-speed data communications.

The site controller 102 may also be configured to accept modifications and/or other input from a user. This may be accomplished via a user interface of the site controller 102 or any other user interface that may be configured to communicate with the site controller 102 through any suitable network or connection. The user interface may include a keyboard, touchscreen, mouse, or other interface components. The site controller 102 is configured to, among other things, affect or change operational data of the field panels 108, as well as other components of the system 100. The site controller 102 may use a building level network (BLN) 122 to exchange system data with other elements on the BLN 122, such as the field panels 108.

Each field panel 108 may comprise a general-purpose processor and is configured to use the data and/or instructions from the site controller 102 to provide control of its one or more corresponding field controllers 110. While the site controller 102 is generally used to make modifications to one or more of the various components of the building automation system 100, a field panel 108 may also be able to provide certain modifications to one or more parameters of the system 100. Each field panel 108 may use a field level network (FLN) 124 to exchange system data with other elements on the FLN 124, such as a subset of the field controllers 110 coupled to the field panel 108.

Each field controller 110 may comprise a general-purpose processor and may correspond to one of a plurality of localized, standard building automation subsystems, such as building space temperature control subsystems, lighting control subsystems, or the like. For a particular embodiment, the field controllers 110 may comprise the model DXR controller available from Siemens. However, it will be understood that the field controllers 110 may comprise any other suitable type of controllers without departing from the scope of the present invention.

To carry out control of its corresponding subsystem, each field controller 110 may be coupled to one or more field devices 112. Each field controller 110 is configured to use the data and/or instructions from its corresponding field panel 108 to provide control of its one or more corresponding field devices 112. For some embodiments, some of the field controllers 110 may control their subsystems based on sensed conditions and desired set point conditions. For these embodiments, these field controllers 110 may be configured to control the operation of one or more field devices 112 to attempt to bring the sensed condition to the desired set point condition. It is noted that in the system 100, information from the field devices 112 may be shared between the field controllers 110, the field panels 108, the site controller 102 and/or any other elements on or connected to the system 100.

In order to facilitate the sharing of information between subsystems, groups of subsystems may be organized into an FLN 124. For example, the subsystems corresponding to the field controllers 110a and 110b may be coupled to the field panel 108a to form the FLN 124a. The FLNs 124 may each comprise a low-level data network that may employ any suitable proprietary or open protocol.

Each field device 112 may be configured to measure, monitor and/or control various parameters of the building automation system 100. Examples of field devices 112 include lights, thermostats, temperature sensors, lighting sensors, fans, damper actuators, heaters, chillers, alarms, HVAC devices, window blind controls and sensors, and numerous other types of field devices. The field devices 112 may be capable of receiving control signals from and/or sending signals to the field controllers 110, the field panels 108 and/or the site controller 102 of the building automation system 100. Accordingly, the building automation system 100 is able to control various aspects of building operation by controlling and monitoring the field devices 112. In particular, each or any of the field devices 112 can generate the data that is processed as described herein.

As illustrated in FIG. 1, any of the field panels 108, such as the field panel 108a, may be directly coupled to one or more field devices 112, such as the field devices 112c and 112d. For this type of embodiment, the field panel 108a may be configured to provide direct control of the field devices 112c and 112d instead of control via one of the field controllers 110a or 110b. Therefore, for this embodiment, the functions of a field controller 110 for one or more particular subsystems may be provided by a field panel 108 without the need for a field controller 110.

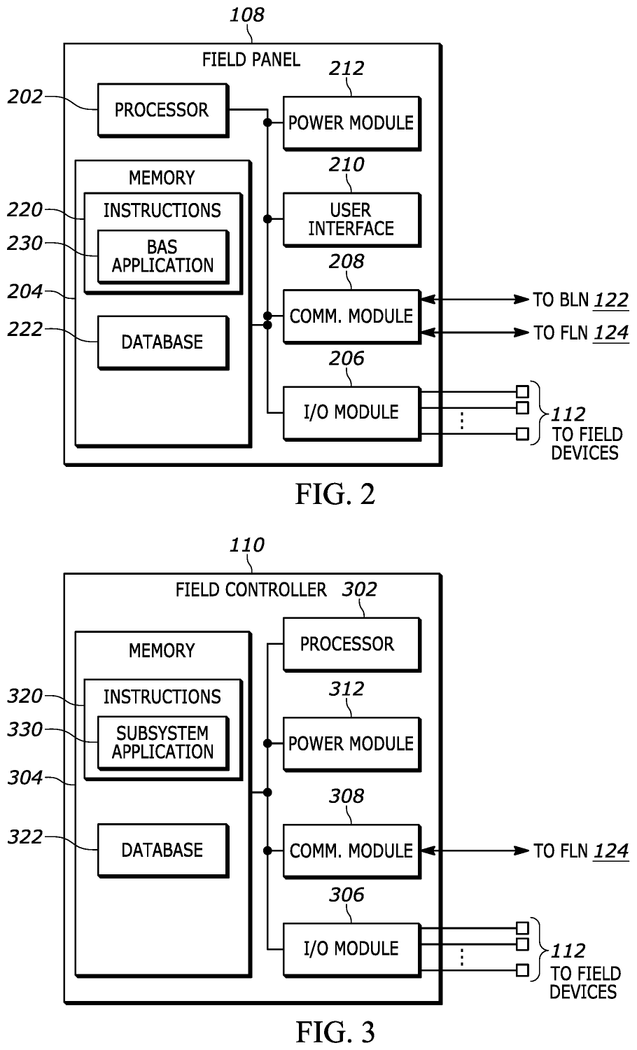

FIG. 2 illustrates details of one of the field panels 108 in accordance with the present disclosure. For this particular embodiment, the field panel 108 comprises a processor 202, a memory 204, an input/output (I/O) module 206, a communication module 208, a user interface 210 and a power module 212. The memory 204 comprises any suitable data store capable of storing data, such as instructions 220 and a database 222. It will be understood that the field panel 108 may be implemented in any other suitable manner without departing from the scope of this disclosure.

The processor 202 is configured to operate the field panel 108. Thus, the processor 202 may be coupled to the other components 204, 206, 208, 210 and 212 of the field panel 108. The processor 202 may be configured to execute program instructions or programming software or firmware stored in the instructions 220 of the memory 204, such as BAS application software 230. In addition to storing the instructions 220, the memory 204 may also store other data for use by the system 100 in the database 222, such as various records and configuration files, graphical views and/or other information.

Execution of the BAS application 230 by the processor 202 may result in control signals being sent to any field devices 112 that may be coupled to the field panel 108 via the I/O module 206 of the field panel 108. Execution of the BAS application 230 may also result in the processor 202 receiving status signals and/or other data signals from field devices 112 coupled to the field panel 108 and storage of associated data in the memory 204, and that data can be processed as described herein. In one embodiment, the BAS application 230 may be provided by or implemented in the DXR Controller commercially available from Siemens Industry, Inc. However, it will be understood that the BAS application 230 may comprise any other suitable BAS control software.

The I/O module 206 may comprise one or more input/output circuits that are configured to communicate directly with field devices 112. Thus, for some embodiments, the I/O module 206 comprises analog input circuitry for receiving analog signals and analog output circuitry for providing analog signals.

The communication module 208 is configured to provide communication with the site controller 102, other field panels 108 and other components on the BLN 122. The communication module 208 is also configured to provide communication to the field controllers 110, as well as other components on the FLN 124 that is associated with the field panel 108. Thus, the communication module 208 may comprise a first port that may be coupled to the BLN 122 and a second port that may be coupled to the FLN 124. Each of the ports may include an RS-485 standard port circuit or other suitable port circuitry.

The field panel 108 may be capable of being accessed locally via the interactive user interface 210. A user may control the collection of data from field devices 112 through the user interface 210. The user interface 210 of the field panel 108 may include devices that display data and receive input data. These devices may be permanently affixed to the field panel 108 or portable and moveable. For some embodiments, the user interface 210 may comprise an LCD-type screen or the like and a keypad. The user interface 210 may be configured to both alter and show information regarding the field panel 108, such as status information and/or other data pertaining to the operation of, function of and/or modifications to the field panel 108.

The power module 212 may be configured to supply power to the components of the field panel 108. The power module 212 may operate on standard 120 volt AC electricity, other AC voltages or DC power supplied by a battery or batteries.

FIG. 3 illustrates details of one of the field controllers 110 in accordance with the present disclosure. For this particular embodiment, the field controller 110 comprises a processor 302, a memory 304, an input/output (I/O) module 306, a communication module 308 and a power module 312. For some embodiments, the field controller 110 may also comprise a user interface (not shown in FIG. 3) that is configured to alter and/or show information regarding the field controller 110. The memory 304 comprises any suitable data store capable of storing data, such as instructions 320 and a database 322. It will be understood that the field controller 110 may be implemented in any other suitable manner without departing from the scope of this disclosure. For some embodiments, the field controller 110 may be positioned in, or in close proximity to, a room of the building where temperature or another environmental parameter associated with the subsystem may be controlled with the field controller 110.

The processor 302 is configured to operate the field controller 110. Thus, the processor 302 may be coupled to the other components 304, 306, 308 and 312 of the field controller 110. The processor 302 may be configured to execute program instructions or programming software or firmware stored in the instructions 320 of the memory 304, such as subsystem application software 330. For a particular example, the subsystem application 330 may comprise a temperature control application that is configured to control and process data from all components of a temperature control subsystem, such as a temperature sensor, a damper actuator, fans, and various other field devices. In addition to storing the instructions 320, the memory 304 may also store other data for use by the subsystem in the database 322, such as various configuration files and/or other information.

Execution of the subsystem application 330 by the processor 302 may result in control signals being sent to any field devices 112 that may be coupled to the field controller 110 via the I/O module 306 of the field controller 110. Execution of the subsystem application 330 may also result in the processor 302 receiving status signals and/or other data signals from field devices 112 coupled to the field controller 110 and storage of associated data in the memory 304.

The I/O module 306 may comprise one or more input/output circuits that are configured to communicate directly with field devices 112. Thus, for some embodiments, the I/O module 306 comprises analog input circuitry for receiving analog signals and analog output circuitry for providing analog signals.

The communication module 308 is configured to provide communication with the field panel 108 corresponding to the field controller 110 and other components on the FLN 124, such as other field controllers 110. Thus, the communication module 308 may comprise a port that may be coupled to the FLN 124. The port may include an RS-485 standard port circuit or other suitable port circuitry.

The power module 312 may be configured to supply power to the components of the field controller 110. The power module 312 may operate on standard 120-volt AC electricity, other AC voltages, or DC power supplied by a battery or batteries.

Typical field devices 112 in an HVAC system of a BAS include air handling units (AHUs). In many HVAC systems, AHUs provide cold air to multiple Variable Air Volume terminals (VAVs), which provide airflow to the rooms by regulating the position of the dampers, and each of these elements are controllable as field devices 112. The AHU can also function as a field controller 110.

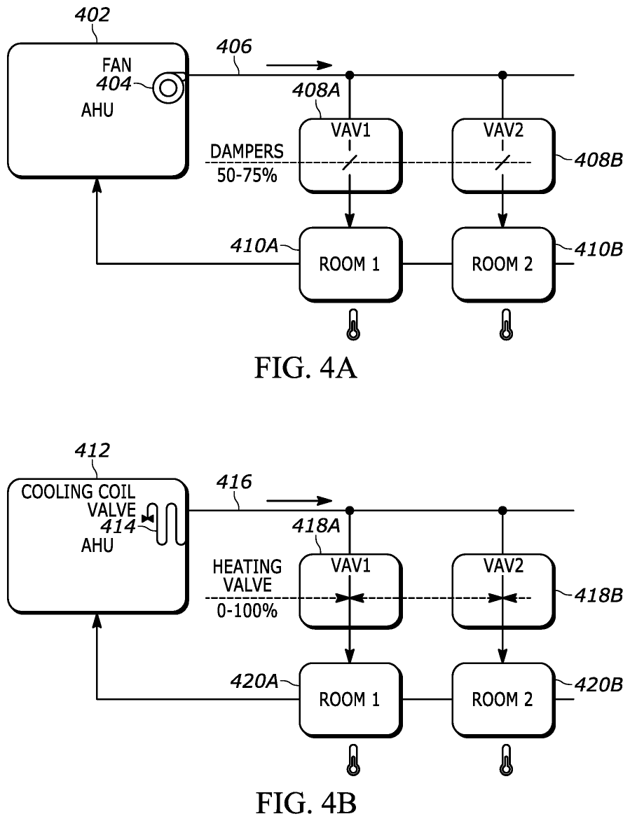

FIGS. 4A and 4B illustrate the use of AHUs in a BAS. As illustrated in these figures, an AHU provides air flow to many VAV boxes for individual room temperature control. The damper opening of on VAV impacts the flow of other rooms connected to the same AHU. If dampers are opened too much, some rooms will not have enough air flow. If most of the dampers are closed too much, the AHU supply fan must run in high speed to meet the supply air flow setpoint at each VAV box. “Trim and response” (T&R) logic can be used automatically tune the parameters. For example, at the start-up phase, each VAV box open the damper can call for more air flow from the AHU. The AHU “responds” to the call by increasing static pressure setpoint slowly. If the VAVs have too much air flow, the overfeed message is sent to the AHU to “trim” the supply air by some amount. Repeating the process, the AHU and the VAVs can reach a set of balanced setpoints to provide just enough supply air.

FIG. 4A illustrates an example of a static pressure and airflow control system that can be managed in accordance with disclosed embodiments. In this figure, AHU 402 uses fan 404 to supply air to different rooms via ducts 406. VAVs 408A and 408B use dampers to control the volume of air delivered to each room. Temperature sensors 410A and 410B detect the temperature in each room. A BAS as described herein can control each of these elements to regulate the temperature and airflow in each room. Note that the ducts 406 deliver the same volume of air to multiple rooms, so the setting of the dampers of VAV 408A affects the amount of air that can be controlled by the dampers of VAV 408B.

FIG. 4B illustrates an example of a cooling and heating coil valves control system that can be managed in accordance with disclosed embodiments. In this figure, cooling coil valve 414 of AHU 412 is used to cool the air delivered by ducts 416 to different rooms. VAVs 418A and 418B use heating valves to volume of heated air delivered to each room. Temperature sensors 420A and 420B detect the temperature in each room. A BAS as described herein can control each of these elements to regulate the temperature and airflow in each room.

The T&R logic is designed the coordinate the air flow damper control among HVAC systems using control loops. In FIG. 4A, T&R logic is used to regulate the static pressure and the airflow to the various rooms and VAVs. In FIG. 4B, T&R logic is used to regulate the opening on the valves of the heating and cooling coils. Together with hardware, software or human error, an incorrect calibration of any of the parameters of any of these two control systems can lead to deviations of the room temperatures with respect to their setpoints among other problems. Given the large number of devices controlled by every system, faults are difficult to diagnose. Manual analysis by an application engineer would require inspecting between dozens and thousands of sensor plots. In normal conditions, the damper positions operate within a range of 50% to 75%. 0% indicates that the damper is fully closed and there is no air flowing, while 100% indicates that the damper is fully open and that the VAV needs a higher static pressure for additional air to flow. A manual fault diagnosis process would require analyzing each of the sensor plots to identify dampers that do not operate within this range and may be starved or overfed.

Disclosed embodiments address a fundamental technical problem of finding the root cause of faults in HVAC systems. Due to the scale of the hardware and the size of the sensor data, manual diagnosis is normally impractical, and often impossible. While the specific implementations described herein are focused on the root cause diagnosis involving T&R logic, disclosed techniques are applicable to general root cause diagnosis involving many different types of HVAC equipment.

Throughout this document, the root cause of any problem is referred to as a “fault” and the observations, measurements, or alerts that indicate that there is a fault are referred to as “events”. Diagnostic systems and methods as disclosed herein are designed to find faults using the information provided by the events. The events are triggered by sensor data when these meet certain rules.

To illustrate that such root cause faults cannot be manually identified, consider an AHU that provides air conditioning to 88 VAV terminal boxes. One fault in the AHU, such as an incorrect static pressure setpoint, may cascade to the VAV boxes. In this scale, it is impractical, if not impossible, to manually diagnose the root cause of a problem. Using typical damper-position data, it is difficult to identify any faults. If the control logic is configured properly, VAV damper openings are expected to vary within a range between 50% and 75%. While some automated analysis can indicate that a fault has occurred, such as an abnormal event that causes the standard deviation of the damper-position data to be significantly lower than normal, the root cause of such a fault cannot practically be determined manually.

The following is an example of the control logic that can be used to control the static pressure and the airflow in AHUs and VAVs is Trim and Response (T&R). One example of a T&R workflow is:
VAVs are overfed if their dampers are opened less than 50%.
VAVs are starving if their dampers are opened about 90%.
The starving VAVs will send requests to the AHU, which will increase the static pressure set point incrementally every fixed time step.
Similarly, the overfed VAVs will request the AHU to reduce the static pressure set point incrementally.

Such a T&R process uses multiple parameters that require adequate tuning before implementation, such as the size of the time-step or the number of VAV requests that are ignored before increasing the static pressure. In practice, it is practically impossible to manually identify the root cause of faults in some large-scale system.

In addition, some faults are sporadic, e.g., if a cooling valve in a VAV has problem and is stuck partially open, it may only be observable on certain summer days when the associated room demands a lower temperature compared to the neighboring rooms. In other cases, the partially opened cooling valve may be enough to ensure the temperature of the room is appropriate for occupant comfort.

The T&R logic is coupled with other hardware faults or control logics issues. For example, the normal operation of AHU static pressure control loop is a prerequisite for the T&R behavior. If the loop is out of tune, it may cause instability in the T&R logic.

In theory, the T&R parameters should be tuned for individual buildings to reach optimal performance. In practice, the parameters are often not tuned because it is time consuming and because, during the tuning process, occupants may experience extreme temperatures. Therefore, T&R logic may not be functionally proper in the first place.

Improper calibration of these parameters can cause a faulty operation of the system that can lead to oscillations in the damper positions, airflows that do not match the setpoints, or room temperatures that deviate from their respective set-points.

Disclose embodiments improve on existing systems in a number of ways. For example, some systems focus only on hardware failures and cannot identify improper parameter configurations as in disclosed embodiments. Other systems do not support such features as using a voting network as a fast approximation of a Bayesian network.

Other systems do not support digital twin-based construction. Rather than requiring users to manually create a complete causal network to captures the relationship among faults and events, disclosed embodiments enable data scientists and application engineers to collaborate and create the causal network together. This is accomplished, for example, by enabling data scientists or other individuals to develop digital twins (DTs), such as an AHU, a VAV, a chiller, a boiler, etc., with partial causal networks inside. An application engineer or other individual can then connect the digital twins together according to the configurations of the building or facility being analyzed.

Where other system require manual tracking and updating of failure rates, disclosed embodiments can automatically update the prior probability, or failure rates, of a fault or an event to improve the fault diagnostic accuracy.

Disclosed embodiments include a novel fault diagnostics system that can specifically detect faults in the control logic that regulates the static pressure, airflow, and cooling and heating coils of the building automation system, and in particular those systems that use elements such as illustrated in FIGS. 4A and 4B.

Disclosed embodiments can analyze the causal relationships between faults and events in a BAS and use these relationships to design a Bayesian network (BN) or similar model such as a voting network.

A system as disclosed herein can use hardware, software, and human-induced failure rates to better estimate the probability that a fault in the control logic has occurred.

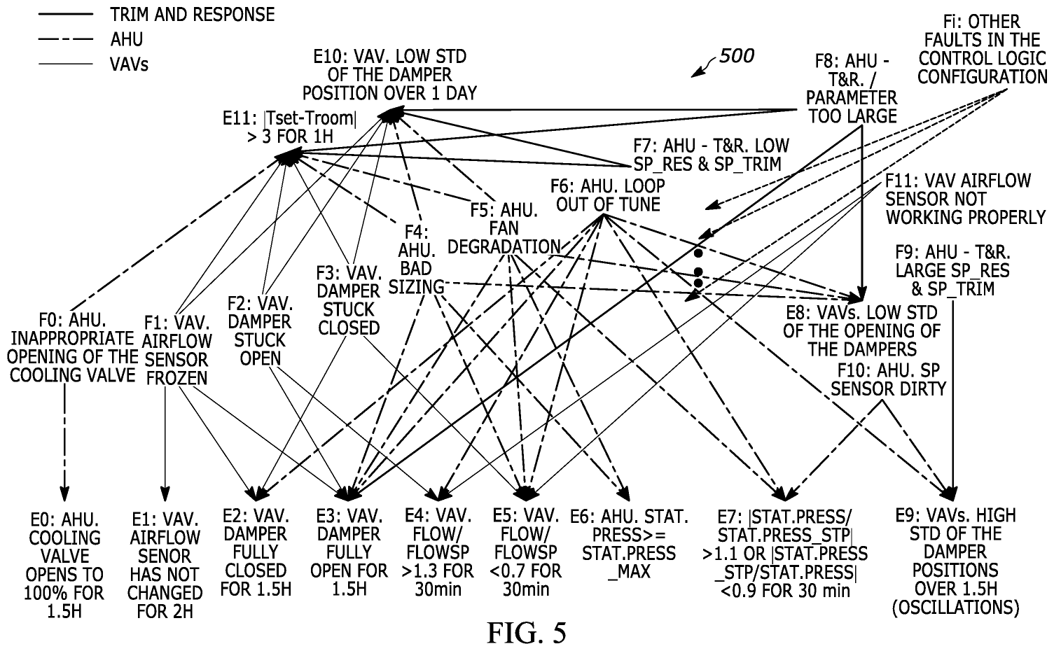

FIG. 5 illustrates an example of a causal network 500 for fault diagnosis analysis in an HVAC control-logic configuration in accordance with disclosed embodiments. In this causal network, a plurality of faults (“F” labels) are associated with a plurality of events (“E” labels) using causal relationships defined by the device or operation type—in this example, whether it is a T&R control, an AHU device, or a VAV device. Note that this illustration is merely an example of such a causal network and is not intended to be limiting or restrictive to a causal network used to analyze operations of any particular system. A causal network such as that illustrated in FIG. 5 can be used as or in the design of a Bayesian network or other network as described herein. A given event E can be potentially caused by one or more faults F, so when an event E is detected, it is important to identify the likely cause of the failure as fault F. In the example of FIG. 5, the causal network 500 indicates that Event E2 (Damper fully closed for 1.5 hours) can be caused by Fault F1 (VAV overflow sensor frozen), Fault F3 (VAV Damper stuck closed), or Fault F6 (AHU Loop out of tune). This example illustrates that the fault-event relationships can be between different units (e.g., a fault F4 in an air handling unit can cause an event E2 in a variable air volume unit) or can be part of a normal trim and response feedback process.

When there are large number of devices, the size of the BN can be difficult to create by a single person. For example, with 88 VAVs, there are about 960 nodes in the BN. Disclosed embodiments can be implemented in a collaborative BN commission framework that allows service engineer, application engineer, data scientists, and other individuals to collaborate and build a large BN. For example, a service engineer can build a database of maintenance issues and tasks that can describe faults and associated events. An application engineer can design a model of the building including specific hardware and interrelations. A data scientist can provide design the causal network for individual equipment, which can be implemented as a part of the BN. The data scientist can also design digital twins of relevant devices, to which the application engineer can link in the building model.

FIG. 5 illustrates an example of a specific design to detect problems in the configuration of a T&R control algorithm (e.g., F7, F8, F9), but the same technique can be used to detect configuration errors in other algorithms used to control devices such as the VAVs' Static Pressure, Airflow, and Cooling and Heating Coils. A causal network as disclosed herein combines faults in the control logic with other hardware, software or human-induced faults at the VAV and AHU level. Given a set of events, a model with very high hardware failure rates or probabilities will return a low probability of failure of the control-logic configuration.

A system as disclosed herein can associate the BN with a conditional probability table (CPT) that defines the probability of each link between a fault to an event. The BN can also use initial probability of each fault. If the initial probability of every fault is constant, the BN can be considered a “static” BN. Disclosed embodiments can employ a novel dynamic BN process, where the initial probability of each fault is a function of time. The each of the probabilities between a fault and an event can be independent of each other and so the sum of the possible faults corresponding to a given event is not necessarily 100%. Each probability reflects the independent likelihood that a given fault can produce a specific event.

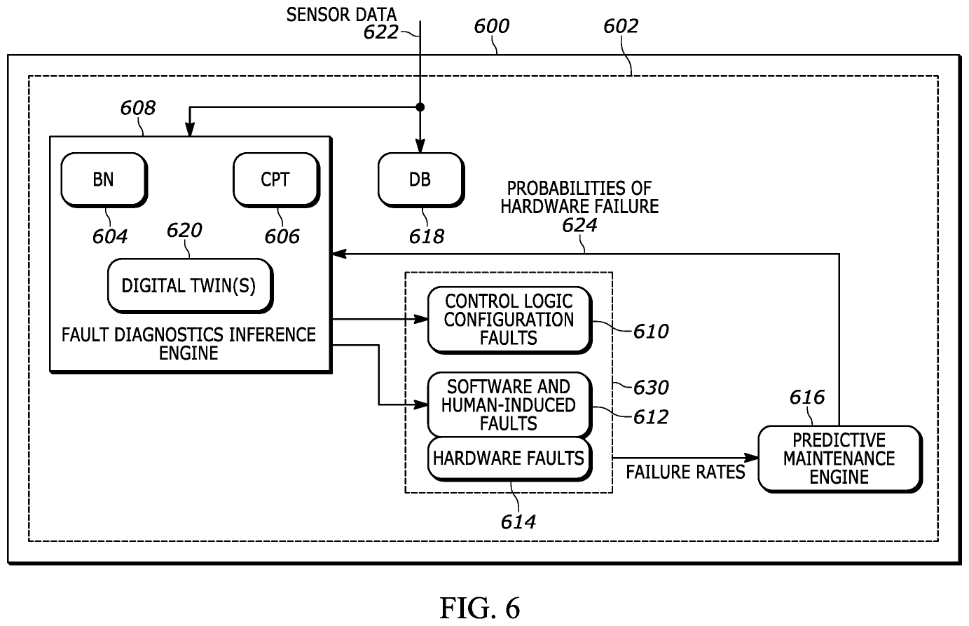

FIG. 6 illustrates an example of elements of a software architecture 602 that can be implemented in a BAS or other data processing system 600 to perform processes as disclosed herein. Data processing system 600 can be, for example, an example of one implementation of the site controller data processing system 102, a client station 106, a report server 104, or other client or server data processing system or controller configured to operate as disclosed herein. The software architecture 602 described here is exemplary and non-limiting; specific implementations may use alternate architectural components to perform similar functions, may call various components by different names, may combine or divide the various operations differently with respect to different components, or otherwise use a different logical structure to perform processes as described herein, and the scope of this disclosure is intended to encompass such variations.

In the exemplary architecture 602, a fault diagnostics inference engine interacts with its BN 604 and associated CPT 606 to identify probabilities of specific faults as associated with defined events. Inference engine 608 identifies faults 630, which can include control-logic configuration faults 610, software and human-induced faults 612, and hardware faults 614. Hardware faults 614 in particular can be used to update failure rates in a predictive maintenance engine 616, which can then update the probabilities of hardware failure 624 to inference engine 608 to update CPT 606 and/or BN 604. However, in disclosed embodiments, any types of faults 630 can be processed as described herein to allow the predictive maintenance engine 616 to update the probabilities of specific faults 630 being the root cause of specific events, whether those faults 630 are control logic configuration faults 610, software and human-induced faults 612, or hardware faults 614.

To illustrate, using the examples of FIGS. 5 and 6, CPT 606 can store a probability associated with each “edge” or arrow between a given fault F and a resulting event E in the causal network 500 (or BN 604) that indicates the probability that the specific event E was caused by that fault F. The probabilities in the CPT 606 are independent of each other, so that they do not necessarily sum to 100%. For example, using the causal network 500 of FIG. 5, the CPT 606 may store CPT values that indicate that Event E2 (Damper fully closed for 1.5 hours) is 58% likely to be caused by Fault F1 (VAV overflow sensor frozen), 35% likely to be cause by Fault F3 (VAV Damper stuck closed), and 20% likely to be caused by Fault F6 (AHU Loop out of tune). As the architecture operates as described herein, the updated sensor data 622 and updated probabilities from predictive maintenance engine 616 are used to update the CPT 606 on a dynamic basis.

An architecture 602 as disclosed herein produces a synergic integration of the fault diagnostics inference engine 608 and the predictive maintenance engine 616. Database (DB) 618 can store any data necessary for the operations of architecture 602, including the determined faults, failure data and predictions, parameters and device information, and otherwise, including, in some embodiments, the BN 604 and CPT 606. Database 618 can be implemented with or as a part of database 222 or database 322. In particular, database 618 can receive and store data 622 from system devices, sensors, etc., including trend sensor data, collectively also referred to herein as “device event data,” from which inference engine 608 identifies faults and determines the causal events. Further, the fault diagnostics inference engine 608 can directly receive the sensor data 622, whether or not sensor data 622 is also stored in database 618. As described in more detail below, inference engine 608 can implement a digital twin 620 for each device being analyzed, and each digital twin 620 can have its own BN and/or CPT.

Fault diagnostics inference engine 608 can determine when data indicating faults or failures is being produced because of control-logic configuration faults 610 or software and human-induced faults 612. Because fault diagnostics inference engine 608, using the dynamic BN 604, CPT 606, and other results from predictive maintenance engine 616, knows when it is likely that a hardware fault will occur, when sensor data indicates that failures or other events are occurring that are inconsistent with predicted hardware failures, fault diagnostics inference engine 608 can determine that these failures are caused by control-logic configuration faults 610 or software and human-induced faults 612. Further, certain control-logic configuration faults 610 or software and human-induced faults 612 can have specific probabilities associated with specific events, so that the probabilities can be predicted and refined in the same manner as any other faults. Some examples of common control-logic configuration faults 610 or software and human-induced faults 612 can include, but are not limited to, changes in setpoints and out-of-range setpoints or data.

A system as disclosed herein enables field engineers to quickly identify individual faulty configuration parameters among thousands of parameters. The challenges of doing so include that some faults are observable only under certain weather conditions, where HVAC equipment are operating in specific modes, that it is hard to repeat the fault and find the root causes, on site and in office hours, and that many parameters, such as those for PID controllers, are tuned by experiments and should be re-tuned occasionally. Due to the time varying nature of commercial buildings, it is hard to accurately estimate when the parameters need to be re-tuned.

Among the technical advantages provided by the systems and methods disclosed herein are the capability of large-scale automatic faulty parameter identification, enabling engineers to diagnose the root cause of HVAC system faults from remote, under any weather conditions and at any time, and identification of faulty or “out-of-tune” parameters in time to avoid complains from occupants.

The predictive maintenance engine 616 can produce the initial and ongoing probability of each fault as a function of time, using a number of different methods to estimate the CPT values for particular implementations.

The predictive maintenance engine 616 can use original equipment manufacturer (OEM) datasheets to determine CPT values, and this information can also be stored in database 618. OEMs often provide the number of failures per device annually or list a Mean Time Before Failure (MTBF) in terms of hours. In a continuous-learning process as described herein, the architecture 602 continuously updates its performance with improved CPT values. That is, the original CPT values as stored in CPT 606 and/or in databased 618 can be based on OEM data or equations, then the predictive maintenance engine 616 can continually, periodically, or occasionally update the CPT values based on log data for each component, such as real-time sensor data 622, sensor data stored in database 618, or trend data for each of the components.

For example, the predictive maintenance engine 616 can calculate the probability of failure at any time interval given the annual failure rate, using:

$${P}_{f} = 1 - {e}^{- r \frac{{T}_{s}}{{N}_{s}}}$$

Where P_{f} is the prior probability of failure F for an event E, assuming r is the annual failure rate, i.e., the annual failures per machine. Tₛ is the sampling time interval in hours, e.g., for a time interval of 15 minute Tₛ=0.25. Ns reflects the MTBF in hours. Note that the probability P_{f} above is static, meaning is not changing with respect to the output of the BN. Using this equation, the system can estimate the probability of failure within any given time interval during a year, e.g., a specific 10 hour duration, given the MTBF from the OEM.

The predictive maintenance engine 616 can use log data, such as stored in database 618, real-time sensor data 622, or trend data for each of the components, with predictive maintenance to determine CPT values. Using log data, the system can update the CPT 606 value for a specific device from fault Fᵢ to event Eⱼ using the definition:

$$P ( {E}_{j} \vert {F}_{i} ) = \frac{N ( {F}_{i} , {E}_{j} )}{N ( {F}_{i} )}$$

where N(Fᵢ,Eⱼ) is the number of time instances when both Fᵢ and Eⱼ; happen, and N(Fᵢ) is the number of instances when Fᵢ happens.

In an exemplary implementation, N(Fᵢ,Eⱼ) and N(Fⱼ) can be retrieved from the maintenance database by one line of SQL query command. N(Fⱼ) is the number of instances when fault Fⱼ happened. In a system as disclosed herein, the inference engine can predict the root-cause fault from a given event. In response, an engineer can visit the site and validate the prediction, fix the fault, then log the real fault in the database. Therefore, it is possible to use one line of query command to find the N(Fᵢ,Eⱼ) from historical data.

The architecture 602 can then extend BN 604 from a static BN to a dynamic BN by, for example, updating P(Fᵢ[k]) based on a predictive maintenance calculation. As illustrated in the example of FIG. 6, the fault diagnostics inference engine 608 can more effectively populate and update database 618 with the failure rates of the HVAC equipment, which can be used by the predictive maintenance engine 616 to estimate the remaining useful life of any devices. Knowing the remaining useful life (RUL), the system can calculate better estimates of the probabilities of hardware failure 624, which are used to improve the fault diagnostics inference engine 608. As a result, the fault diagnostics inference engine 608 and the predictive maintenance engine 616 update each other iteratively using historical data.

For example, consider that the fault diagnostics inference engine 608 detects a valve failure with the probability of 90% on day 1, i.e., P(Fᵥ[1])=900%.

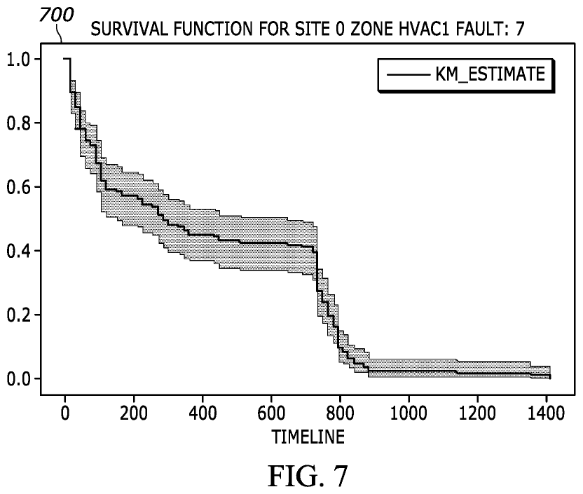

FIG. 7 illustrates an example of a survival curve 700 for this valve from predictive maintenance. Survival curve 700 indicates that that if the probability of survival on day 1 is 100% (Pₛ[1]=100%), then the survival rate on Pₛ[7]=95%. The system can estimate the failure probability of the valve on the 7-th day as

P(Fᵥ[7])=1−(1−P(Fᵥ[1]))×Pₛ[7]=90.5%

Subsequently, the system can use the 90.5% figure as the initial probability when processing the data 7 days later. A generic formula that can be used for such failure prediction is:

P(Fᵢ[k])=1−(1−P(Fᵢ[1]))×Pₛ[k]

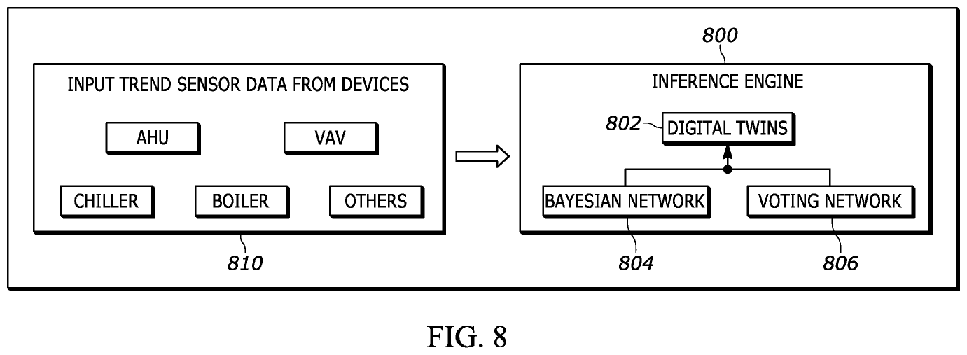

FIG. 8 illustrates an example of a structure of a fault diagnostics inference engine 800 in accordance with disclosed embodiments. In this example, the inference engine 800 includes digital twins 802 of one or more devices in the system being examined, such as an HVAC system or BAS.

The each of the digital twins 802 can be associated with a Bayesian network 804, in various embodiments. In other embodiments, each of the digital twins 802 can be also or alternatively be associated with a voting network 806.

The inference engine 80 can receive, as input, sensor data 810 from various devices. In a BAS or HVAC implementation, these can include an AHU, a VAV, a chiller, a boiler, and/or other device. Using the inputs, the inference engine can determine problem areas in the data and the probably causes/faults causes the problem areas in the data.

In various embodiments, each modeled device has its own Bayesian network, in which some of the causal connections or “edges” are open and are used to connect faults in various devices. Source edges have a known origin but do not point to any specific node. Sink edges have a known fault or event to which they point but an unknown origin. Source and sink edges are linked to each other and used to connect faults in a device with faults or events in other devices which they can trigger in cascade. For example, a source edge for a first device may describe a fault that actually manifests as an event in a second device. The source edge in the first device is linked to the corresponding sink edge, associated with the event, in the second device. An “inner” edge is an edge between a fault and an event within a single device.

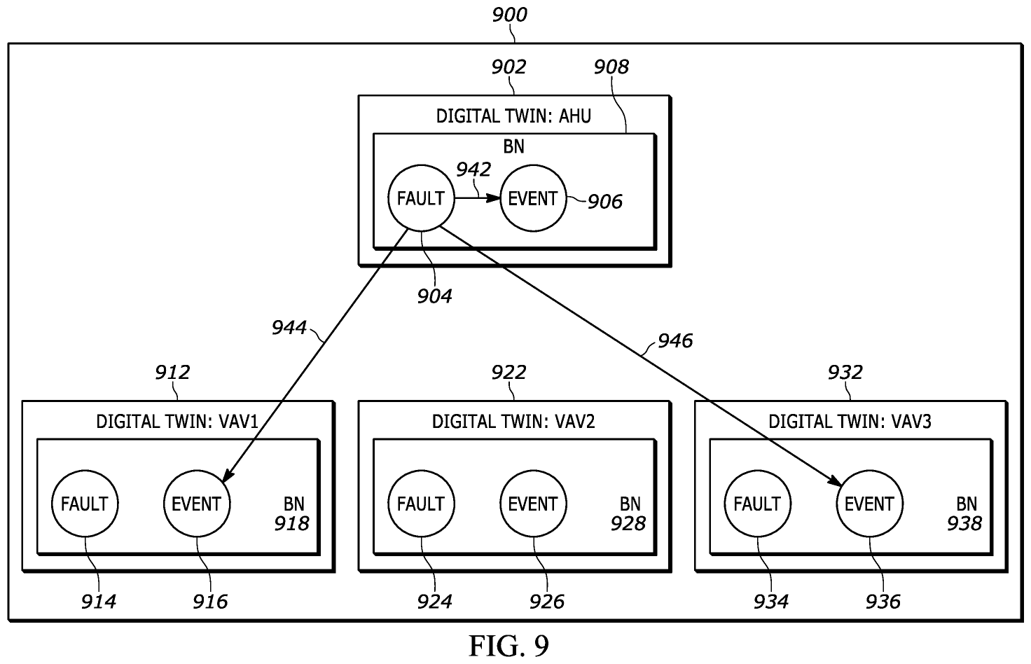

FIG. 9 illustrates an inference engine 900 in accordance with disclosed embodiments, to illustrate the relation of edges between different digital twins. In this example, inference engine has multiple digital twins: AHU digital twin 902, VAV1 digital twin 912, VAV2 digital twin 922, and VAV3 digital twin 924. Each digital twin has, in this simplified example, one fault, one event, and a BN. Specifically, AHU digital twin 902 includes a fault 904, an event 906, and a BN 908 that includes relationships and probabilities between faults and events. VAV1 digital twin 912 includes a fault 914, an event 916, and a BN 918 that includes relationships and probabilities between faults and events. VAV2 digital twin 922 includes a fault 924, an event 926, and a BN 928 that includes relationships and probabilities between faults and events. VAV3 digital twin 932 includes a fault 934, an event 936, and a BN 938 that includes relationships and probabilities between faults and events.

Bayesian networks can be linked together, in disclosed embodiments, when equipment is part of the same subsystem. In this example, VAV1 (represented by digital twin 912), VAV1 (represented by digital twin 922), and VAV1 (represented by digital twin 932) are subsystems of the AHU represented by digital twin 902, so the BNs 908, 918, 928, and 938 can be linked together with edges.

In this example, fault 904 can be linked to event 906, event 916, and event 936 (typically with different probabilities). The edge 942 between fault 904 and event 906 is internal to BN 908 and is an inner edge. Edge 944, between fault 904 and event 916, and edge 946, between fault 904 and event 936, are source edges with respect to BN 908—they have a known source at fault 904, but do not point to a specific node within BN 908. The opposite is true from the other perspective; edge 944 is a sink edge with respect to BN 918 since it has an unknown origin but points to known event 916, and edge 946 is a sink edge with respect to BN 938 since it has an unknown origin but points to known event 936.

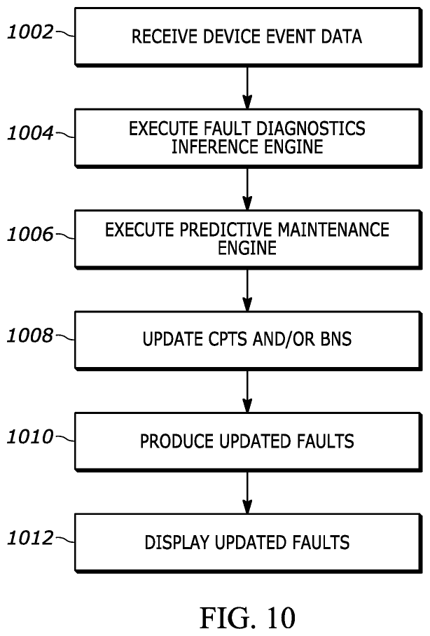

FIG. 10 illustrates an example of a process in accordance with disclosed embodiments that can be performed, for example, by a data processing system, controller, or other processor in a BAS system or other system, or any combination of multiple such systems. The device executing such a process is referred to generically as the “system” below. Any or all of the features discussed herein or in the incorporated applications can be used in a process as described below.

The system receives device event data for a plurality of devices (1002). As used in this process, “receiving” can include loading from storage, receiving from another device or processes, receiving via an interaction with a user, or otherwise. In specific embodiments, the device event data is received, directly or indirectly, from one or more event detection applications that identify device or system events based on sensor data. The device event data can include, in some embodiments, sensor data for a device. The devices can be, in a BAS implementation, any HVAC or other building device, and the sensor data can be any data received from a field device 112, field controller 110, or other device. The system can store the device event data in a database that is accessible by a fault diagnostics inference engine and a predictive maintenance engine.

The system executes a fault diagnostics inference engine to determine faults corresponding to the device event data (1004). The faults can include control-logic configuration faults, software and human-induced faults, and/or hardware faults 614. The inference engine can include and base decisions on a Bayesian network that associates device events with device faults and can include a conditional probability table associated with the Bayesian network. The Bayesian network(s) can be dynamic Bayesian networks that are updated from a predictive maintenance engine. The fault diagnostics inference engine can include a plurality of digital twins each corresponding to a different device. Each digital twin can include a respective Bayesian network. The fault diagnostics inference engine can maintain links between Bayesian networks of digital twins corresponding to different devices.

In various embodiments, the fault diagnostics inference engine includes a plurality of DTs each corresponding to a different device, where each DT is designed by a data scientist and includes a respective Bayesian network, such as illustrated above with respect to such elements as AHUs, VAVs, chillers, etc. An Application Engineer can link DTs according to a specific building's configuration. A service engineer can be responsible for providing maintenance to the system and logging specific tasks in a database within a job ticket tracking system.

The system executes the predictive maintenance engine to produce probabilities of hardware failures based on the determined faults and the device event data (1006).

The system updates the CPTs and/or the Bayesian networks based on the probabilities of hardware failures (1008). The inference engine can then use the updated failure data in subsequent processes to provide more accurate fault data, creating an ongoing machine-learning process.

The system produces updated faults by the predictive maintenance engine according to the updated CPTs and/or Bayesian networks (1010). The updated faults can include any of the faults above.

The system can display, to a user, the updated faults or any other of the data described above, and/or can store or transmit such data as may be useful in a given implementation (1012). Significantly, updated probabilities of specific faults can then be used by the system or by users to rank or prioritize the order in which the possible faults are investigated by operators or service personnel. When the potential faults associated with a specific event are prioritized or ranked according to their relative priorities, the actual, specific fault can be much more efficiently identified and cured. Such a ranking or prioritization can be displayed, stored, or transmitted as described herein.

In some embodiments, after 1012, the predictive maintenance engine can then estimate both the current and the future failure rate for any given time for the given equipment, based on the updated faults. The inference engine can thereafter provide a better estimation on the root cause fault based on these updated failure rates.

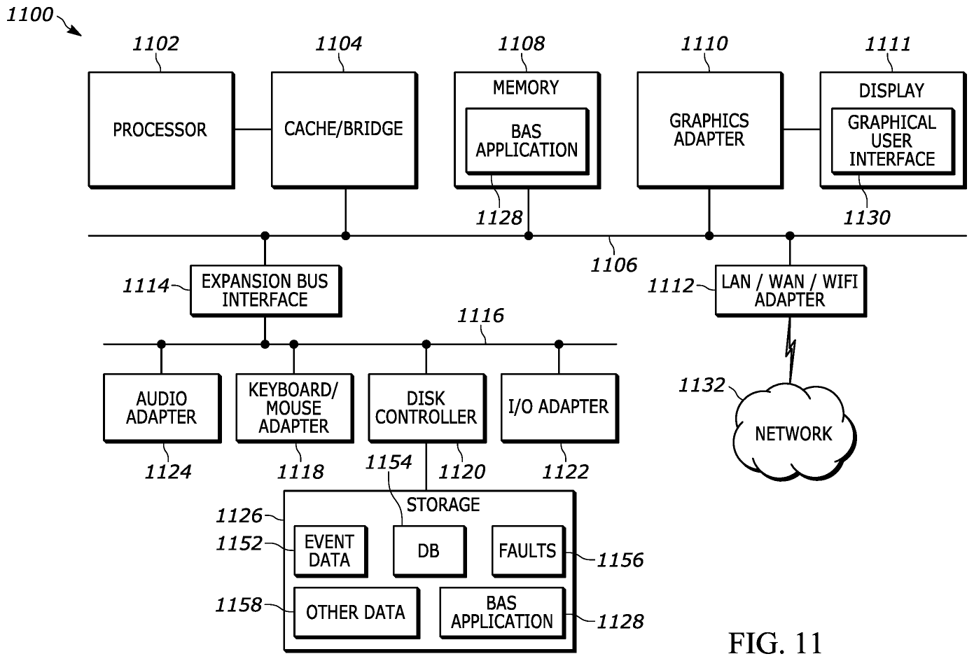

FIG. 11 illustrates a block diagram of a data processing system 1100 in which various embodiments can be implemented. The data processing system 1100 is an example of one implementation of the site controller data processing system 102 in FIG. 1 and of an implementation of a data processing system 400 in FIG. 4, and can be used as an implementation of any data processing system configured to operate as described herein.

The data processing system 1100 includes a processor 1102 connected to a level two cache/bridge 1104, which is connected in turn to a local system bus 1106. The local system bus 1106 may be, for example, a peripheral component interconnect (PCI) architecture bus. Also connected to the local system bus 1106 in the depicted example are a main memory 1108 and a graphics adapter 1110. The graphics adapter 1110 may be connected to a display 1111.

Other peripherals, such as a local area network (LAN)/Wide Area Network (WAN)/Wireless (e.g. WiFi) adapter 1112, may also be connected to the local system bus 1106. An expansion bus interface 1114 connects the local system bus 1106 to an input/output (I/O) bus 1116. The I/O bus 1116 is connected to a keyboard/mouse adapter 1118, a disk controller 1120, and an I/O adapter 1122. The disk controller 1120 may be connected to a storage 1126, which may be any suitable machine-usable or machine-readable storage medium, including, but not limited to, nonvolatile, hard-coded type mediums, such as read only memories (ROMs) or erasable, electrically programmable read only memories (EEPROMs), magnetic tape storage, and user-recordable type mediums, such as floppy disks, hard disk drives, and compact disk read only memories (CD-ROMs) or digital versatile disks (DVDs), and other known optical, electrical, or magnetic storage devices.

Storage 1126 can store any program code or data useful in performing processes as disclosed herein or for performing building automation tasks. In particular embodiments, storage 1126 can include such elements as device event data 1152, database 1154, faults 1156, and other data 1158, as well as a stored copy of BAS application 1128. Other data 1158 can include the software architecture, any of its elements, or any other data, programs, code, tables, or other information or data discussed above.

Also connected to the I/O bus 1116 in the example shown is an audio adapter 1124, to which speakers (not shown) may be connected for playing sounds. The keyboard/mouse adapter 1118 provides a connection for a pointing device (not shown), such as a mouse, trackball, trackpointer, etc. In some embodiments, the data processing system 1100 may be implemented as a touch screen device, such as, for example, a tablet computer or a touch screen panel. In these embodiments, elements of the keyboard/mouse adapter 1118 may be implemented in connection with the display 1111.

In various embodiments of the present disclosure, the data processing system 1100 can be used to implement as a workstation or as site controller 102 with all or portions of a BAS application 1128 installed in the memory 1108, configured to perform processes as described herein, and can generally function as the BAS described herein. For example, the processor 1102 executes program code of the BAS application 1128 to generate graphical interface 1130 displayed on display 1111. In various embodiments of the present disclosure, the graphical user interface 1130 provides an interface for a user to view information about and control one or more devices, objects, and/or points associated with the building automation system 100. The graphical user interface 1130 also provides an interface that is customizable to present the information and the controls in an intuitive and user-modifiable manner.

Those of ordinary skill in the art will appreciate that the hardware depicted in FIG. 11 may vary for particular implementations. For example, other peripheral devices, such as an optical disk drive and the like, also may be used in addition to or in place of the hardware depicted. The depicted example is provided for the purpose of explanation only and is not meant to imply architectural limitations with respect to the present disclosure.

One of various commercial operating systems, such as a version of Microsoft Windows™, a product of Microsoft Corporation located in Redmond, Wash., may be employed if suitably modified. The operating system may be modified or created in accordance with the present disclosure as described, for example, to implement discovery of objects and generation of hierarchies for the discovered objects.

The LAN/WAN/WiFi adapter 1112 may be connected to a network 1132, such as, for example, MLN 104 in FIG. 1. As further explained below, the network 1132 may be any public or private data processing system network or combination of networks known to those of skill in the art, including the Internet. Data processing system 1100 may communicate over network 1132 to one or more computers, which are also not part of the data processing system 1100, but may be implemented, for example, as a separate data processing system 1100. It saves time and money by helping service engineers diagnose faults more efficiently.

Disclosed embodiments improve over other predictive maintenance systems and help building energy managers better plan for the purchase of new equipment and save money. A Bayesian-network-based inference engine as disclosed herein returns the probabilities associated to every fault that could have had happened in the control-logic configuration, providing service engineers with valuable information to prioritize which faults to look for first and to save time in diagnosis and resolution. The Bayesian network can be used to diagnose faults in historical data that have occurred due to a wrong configuration of the control logic. These faults, which are not due to hardware failures, can be discarded when calculating the failure rates that are used in the design of predictive maintenance systems (such as equipment survival curves). Disclosed embodiments can include dynamic Bayesian Networks in which the BN and predictive maintenance processes are connected together.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of a system used herein may conform to any of the various current implementations and practices known in the art.

The following documents are incorporated by reference herein:
Steve Taylor, “Resetting Setpoints Using Trim & Respond Logic,” ASHRAE Journal, 2015.
Xiao, L., Zhao, Y., Wen, J., Wang, S., “Bayesian network based FDD strategy for variable air volume terminals”, Automation in Construction, 2013.
Zhao, Y., Wen, J., Wang, S., “Diagnostic Bayesian networks for diagnosing air handling units faults—Part II: Faults in coils and sensors”, Applied Thermal Engineering, 2015.
Steve Taylor, “Increasing Efficiency With VAV System VAV System Static Pressure Static Pressure Setpoint Reset,” ASHRAE Journal 2007.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

What is claimed is:

1. A method in a building automation system, the method performed by a data processing system and comprising:
receiving device event data for a plurality of devices;
executing a fault diagnostics inference engine to determine faults corresponding to the device event data, wherein the fault diagnostics inference engine includes a dynamic Bayesian network and a conditional probability table;
executing a predictive maintenance engine to produce probabilities of hardware failures based on the determined faults and the device event data;
updating the conditional probability table based on the probabilities of hardware failures;
producing updated faults by the predictive maintenance engine according to the updated conditional probability table; and
displaying the updated faults.

2. The method of claim 1, wherein the faults include one or more of control-logic configuration faults, software and human-induced faults, or hardware faults.

3. The method of claim 1, wherein the updated faults include control-logic configuration faults.

4. The method of claim 1, wherein the fault diagnostics inference engine includes a plurality of digital twins each corresponding to a different device.

5. The method of claim 4, wherein each digital twin includes a respective Bayesian network.

6. The method of claim 5, wherein the fault diagnostics inference engine maintains links between Bayesian networks of digital twins corresponding to different devices.

7. The method of claim 5, wherein each digital twin includes a respective conditional probability table.

8. The method of claim 4, wherein each digital twin includes a respective voting network.

9. The method of claim 1, wherein the predictive maintenance engine produces initial and ongoing probabilities of faults as a function of time.

10. The method of claim 1, wherein the predictive maintenance engine calculates a probability of failure at any time interval for a device from an annual failure rate of the device.

11. A building automation system including a data processing system for processing device event data for a plurality of devices in the building automation system, the data processing system configured to:
receive device event data for a plurality of devices;
execute a fault diagnostics inference engine to determine faults corresponding to the device event data, wherein the fault diagnostics inference engine includes a dynamic Bayesian network and a conditional probability table;
execute a predictive maintenance engine to produce probabilities of hardware failures based on the determined faults and the device event data;
update the conditional probability table based on the probabilities of hardware failures;
produce updated faults by the predictive maintenance engine according to the updated conditional probability table; and
display the updated faults.

12. The building automation system of claim 11, wherein the faults include one or more of control-logic configuration faults, software and human-induced faults, or hardware faults.

13. The building automation system of claim 11, wherein the fault diagnostics inference engine includes a plurality of digital twins each corresponding to a different device.

14. The building automation system of claim 13, wherein each digital twin includes a respective Bayesian network.

15. The building automation system of claim 14, wherein the fault diagnostics inference engine maintains links between Bayesian networks of digital twins corresponding to different devices.

16. The building automation system of claim 14, wherein each digital twin includes a respective conditional probability table.

17. The building automation system of claim 13, wherein each digital twin includes a respective voting network.

18. The building automation system of claim 11, wherein the predictive maintenance engine produces initial and ongoing probabilities of faults as a function of time.

19. The building automation system of claim 11, wherein the predictive maintenance engine calculates a probability of failure at any time interval for a device from an annual failure rate of the device.

20. A non-transitory computer-readable medium storing executable code that, when executed causes a data processing system of a building automation system to:
receive device event data for a plurality of devices;
execute a fault diagnostics inference engine to determine faults corresponding to the device event data, wherein the fault diagnostics inference engine includes a dynamic Bayesian network and a conditional probability table;
execute a predictive maintenance engine to produce probabilities of hardware failures based on the determined faults and the device event data;
update the conditional probability table based on the probabilities of hardware failures;
produce updated faults by the predictive maintenance engine according to the updated conditional probability table; and
display the updated faults.
